(19) United States
(12) Patent Application Publication
(10) Pub. No.: US 2018/0173989 A1
(43) Pub. Date: Jun. 21, 2018

(54) PROCESS AND SYSTEM OF IDENTIFICATION OF PRODUCTS IN MOTION IN A PRODUCT LINE

(71) Applicant: VALID SOLUÇÓES E SERVIÇOS DE SEGURANÇA EM MEIOS DE PAGAMENTO E IDENTIFICAÇÃO S.A., Rio de Janiero (BR)

(72) Inventors: Antonio Ferreira DA SILVA FILHO, Rio de Janeiro (BR); César Augusto DA SILVA CHAGAS, Rio de Janeiro (BR)

(21) Appl. No.: 15/579,868

(22) PCT Filed: Jun. 6, 2016
(86) PCT No.: PCT/BR2016/050127

§ 371 Date: Dec. 5, 2017

(30) Foreign Application Priority Data
Jun. 10, 2015 (BR) BR1020150135912

(51) Int. Cl. G06K 9/46; G06K 9/78; G06K 7/14

(52) U.S. Cl. CPC G06K 9/46; G06F 17/30247; G06K 7/1447; G06K 9/78

(57) ABSTRACT

The present invention relates to processes employed for the automatic quantification of a specific product (2) in a production line. More particularly, the present invention relates to processes that enable the identification of the brand and/or trade name of products (2) in motion during the production in an automated manner. The objective of the present invention is to provide an efficient process and identification system for products moving in a production line, conciliating the capture of images of the product to be identified with the reading of their respective bar code (4) without human intervention and allowing the minimization of operational failures and fraud.

### TECHNICAL FIELD

The present invention relates to processes employed for the automatic control of a specific product in a production line. More particularly, the present invention relates to processes that enable the identification of the brand and/or trade name of products in motion during the production in an automated manner.

### DESCRIPTION OF THE STATE OF THE ART

Due to the need to control production in the production lines, either in the interest of the manufacturer or to ensure the effective collection of taxes, the correct recognition of a given product must be done before the product reaches the market, that is, in the factory premises, at the place of manufacture.

As a rule, products delivered to retail are provided with one-dimensional bar codes, which could be used for the recognition task. However, during their motion, the products may rotate to an unfavorable position for the resource responsible for capturing the image, making the bar code not visible, and thus, not allowing due recognition of the product.

Currently, the identification of the products in the production line is usually done by reading printed codes on the product packaging.

The identification of products correctly in the production sites is an extremely complex operation, due to the process conditions that impact the analysis of the product.

The major difficulty in recognizing products under production is mainly due, but not limited to, the following conditions:
the capture of images is done with the products moving at high speed, with the possibility of the product being in different positions at the moment of the image capture;
the product is made of different materials; and
the possibility of the product being moist (presence of water).

An alternative to overcome the aforementioned difficulty is the use of the combination of different resources for image acquisition. However, such an alternative is difficult to apply industrially, due to the technical difficulty to synchronize these resources, their high cost and the time of processing of the product image recognition.

The present invention proposes an innovative alternative, by conciliating product image capture with bar code reading, making the brand and/or trade name recognition economically and technically feasible, reliable and fast, wherein the great advantage of this alternative consists in eliminating human intervention, allowing the minimization of operational failures and fraud.

### OBJECTIVES OF THE INVENTION

The of objective of the present invention is to provide efficient process and identification system for products moving in a production line, conciliating the capture of images of the product to be identified with the reading of its respective bar codes without human intervention and allowing the minimization of operational failures and fraud.

### SUMMARY OF THE INVENTION

In order to achieve the above-described objects, the present invention provides a process for identifying products (2) moving in a production line through two steps, which are:
a) Train the Information System (10); and
b) Analyze in real time the information captured by the resource (1) to capture images, where the same resource (1) also reads a bar code (4) printed on the product (2) if the product (2) is in a favorable position for the resource (1) to read the bar code (4).

The present invention further provides a system capable of carrying out the above-described process.

### DESCRIPTION OF THE FIGURE

The detailed description shown below refers to the attached FIGURE, wherein:

FIG. 1 shows a block diagram of the process according to the preferred embodiment of the present invention.

### DETAILED DESCRIPTION OF THE INVENTION

This description starts with a preferred embodiment of the invention. Nonetheless, the invention is not limited to this specific embodiment, as it will be evident for a person skilled in the art.

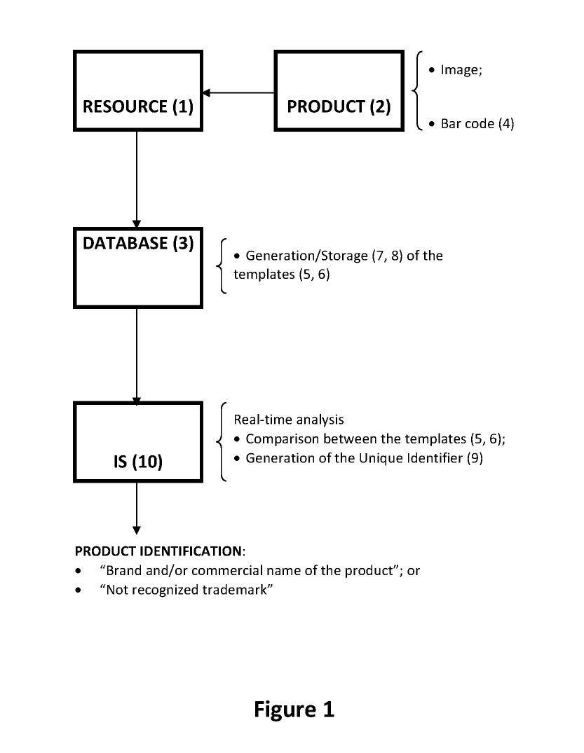

FIG. 1 shows, in general, the process of identifying products (2) of a production line. The following solution was designed to allow the quantitative control of production, trademark recognition, real-time analysis of products (2) and registration of the information obtained in database (3).

The present invention contemplates an Information System—IS (10), which allows to register images of one or more products (2), linking it to its specific commercial bar code(s) (4).

The IS (10) in particular consists of integrated (neural) information networks that allow the association of characteristics of an image with a specific commercial bar code (4).

The first step of the process according to the present invention is related to the training of IS (10). This step consists of using a resource (1) to capture images of the product (2) moving in a production line, in order to extract unique characteristics of the product that allow its identification, where the unique characteristics extracted from the captured images of a product (2) are linked to a specific commercial bar code (4). That is, a product “reference” (2) is stored within a mathematical model of the integrated networks, resulting from a training step.

This step can be performed in a test environment (laboratory or pilot plant, for example), but is preferably performed in the manufacturing environment of the product (2), under nominal production regime.

The unique characteristics extracted from the products (2) during the training step of the IS (10) comprise a data packet called the template (which is the abovementioned “reference”). The template is a mapping of subdivisions of the image and/or of each of its pixels, quantifying, for example, the intensity of the colors in each of those subdivisions and the position that this subdivision occupies in said image. It is important to note that the device that captures the images of the product (2) is also capable of capturing (reading) the bar code (4) of the product (2). This device may be Basler's apparatus (8)—ACA 640, or some other apparatus (8), which has similar characteristics.

One can see that it is possible to save more than one template for one or more products (2) in the database (3) of the IS (10).

The second step of the process of the present invention relates to the real-time analysis of the characteristics contained in the images of the products (2) captured in the production line comparing them with the previously stored templates (6) in the IS (10), during the training step.

Real-time analysis consists of performing the capture of product images (2) in a production or test environment to extract their unique characteristics and, thus, generate the templates of the products (2) (generated templates (5)), where the commercial bar code (4) of the product (2) can be extracted in the same image capture operation if the product (2) is in a favorable position to enable the resource (1) to read the bar codes (4).

Then, after the determination of the product template (2) under analysis (generated template (5)), a comparison is made between this generated template (5) for the product (2) and the stored templates (6) in the database data (3) of the IS (10) during the training step.

The real-time analysis is carried out in an iterative way and at each analysis the stored template (6) is compared with a new generated template (5) (of the product). Integrated networks, by definition, always provide a result in the form of probability ofpositive result for the correlation between the compared templates, for example, 35%, 40% or 50% proximity/similarity between the generated template (5) with a stored template (6); and negative result for the disparity/difference correlation between the generated template (5) with a stored template (6), because only the probability of positive result provided by the integrated networks does not guarantee that the product (2) under analysis (generated template (5)) correspond to one of the stored templates (6), since the value provided by the integrated networks will never be 100% similar between the compared templates, due to the intrinsic margin of error of the mathematical model of the integrated networks. This problem is solved by cross-referencing, where the limits of positive and negative results that are to be adopted for considering the product (2) under analysis (generated template (5)) identified, that is, wherein a generated template (5) corresponds to a stored template (6).

During analysis of the product (2), where the integrated networks are fed with captured images of the product (2) to be analyzed, hit limits (positive result) and error limits (false positive and false negative) are provided, which are variable, and a person skilled in the art would be able to determine it according to the parameters of each process. For example, in case of recognition of cans, the probability of an acceptable positive result is at least 55% (in this case, false positive and false negative rates could amount together to, at most, 45%).

The comparison between the obtained image (generated template (5)) and the recorded image (stored template (6)) is performed by the IS (10), wherein at each reading/capture of the images of the product (2) a comparison with the stored template(s) (6) is made in the integrated networks.

The software (7) used in this comparison process, carried out in the real-time analysis step, is the Identification Application, developed by the company VALID, and the apparatuses (8) are cameras and bar code readers (4), conventional models already found in the market.

In parallel with the real-time analysis step of the templates, the commercial bar code (4), if captured, is decoded.

The IS (10) generates a unique identifier (9) for the product (2), which may be a unique identification sequence of unique numbers and letters for the product (2), when recognizing the template and/or the bar code (4), that is, the IS (10) also generates the unique identifier (9) of the product (2) with only the identification of a parameter, template and/or bar code (4).

With the unique identifier (9) of the product (2), the brand and/or trade name is informed. If IS (10) cannot identify the template and decode the bar code (4), the IS (10) will emit some type of signal indicating the non-recognition of the template, such as, for example, the message “Trademark not recognized”.

As already mentioned above, the present invention further provides a system capable of performing the above-described process. Such a system comprises, in addition to the IS (10), all of the aforementioned apparatuses (8) responsible for carrying out the steps described above.

Countless variations falling within the scope of protection of the present application are allowed. Therefore, it is to be emphasized that this invention is not limited to the specific configurations/embodiments described above.

1. A method of identifying products in motion in a production line, characterized in that it contains an Information System and comprises the steps of:
a) Training the IS, where the training comprises of using a resource to capture images of a product in motion in a production line to extract unique characteristics of the product and store those characteristics in a database of the IS; and
b) Analyzing in real time the information of the product captured by the resource to capture images, wherein the same resource also reads a bar code printed on the product.

2. The method according to claim 1, wherein the IS allows recording images of one or more products.

3. The method according to claim 1, wherein the IS comprises integrated (neural) information networks that allow the association of characteristics of an image with a specific commercial bar code.

4. The method according to claim 1, wherein in the step of training the IS, the unique characteristics extracted from the captured images of the product are linked to a specific commercial bar code.

5. The method according to claim 1, wherein the step of training the IS can be performed in a test environment, but is preferably carried out in the manufacturing environment of the product, under nominal production regime.

6. The method according to claim 1, wherein the unique characteristics extracted from the products during the training step of the IS comprise a data packet called a template, wherein a template is a mapping of subdivisions of the image and/or of each of its pixels, quantifying the intensity of the colors in each of these subdivisions and the position that this subdivision occupies in said image.

7. The method according to claim 1, wherein the resource for capturing images is a device which is also capable of reading the bar code of the product.

8. The method according to claim 1, wherein it is possible to record more than one template for one or more products in the database of the IS.

9. The method according to claim 1, wherein the real-time analysis step consists of comprises:
capturing images of the product for extracting their unique characteristics and generating the template of the product, wherein, in the same image capture operation, the commercial bar code of the product can be extracted;
after the determination of the product template, a comparison is made between this generated template for the product and the stored templates in the database data of the IS during the training step, and
the real-time analysis is carried out in an iterative way and at each analysis the stored template is compared with a new generated template.

10. The method according to claim 3, wherein the integrated networks provide a result in the form of probability of a positive proximity/similarity result for the correlation between the compared templates and negative results for the disparity/difference between the compared templates whereas the negative and positive result limits which must be adopted for considering the generated template as being identified are provided by one skilled in the art.

11. The method according to claim 10, wherein the comparison process performed in the real-time analysis step uses a software, which is the Application Identification one, and apparatuses such as cameras and bar code readers.

12. The method according to claim 1, wherein in parallel with the real-time analysis step of the templates, the commercial bar code, if captured, is decoded.

13. The method according to claim 1, wherein the IS generates a unique identifier for the product when recognizing the commercial template and/or bar codes of the product.

14. The method according to claim 13, wherein the unique identifier of the product informs the brand and/or trade name of the product and, if the IS does not identify the template and does not decode the bar code, the IS will emit a signal indicating the non-recognition of the template, preferably the message “Trademark not recognized”.

15. A system of identifying products in motion in a production line, wherein the system contains an Information System (IS) and comprises:
Means for training the IS, where the training comprises using a resource to capture images of the product in motion in a production line to extract unique characteristics of the product and store those characteristics in a database of the IS; and
Means for analyzing in real time the information of the product captured by the resource to capture images, wherein the same resource also reads a bar code printed on the product.
